(19) United States
(12) Patent Application Publication
(10) Pub. No.: US 2008/0225952 A1
(43) Pub. Date: Sep. 18, 2008

(54) SYSTEM AND METHOD FOR PROVIDING IMPROVED RESIDUAL PREDICTION FOR SPATIAL SCALABILITY IN VIDEO CODING

(75) Inventors: Xianglin Wang, Santa Clara, CA (US); Justin Ridge, Sachse, TX (US)

Correspondence Address: FOLEY & LARDNER LLP, P.O. BOX 80278, SAN DIEGO, CA, 92138-0278, US

(73) Assignee: Nokia Corporation

(21) Appl. No.: 12/048,160

(22) Filed: Mar. 13, 2008

Related U.S. Application Data
(60) Provisional application No. 60/895,092, filed on Mar. 15, 2007.
(60) Provisional application No. 60/895,948, filed on Mar. 20, 2007.

(51) Int. Cl. H04N 7/26

(52) U.S. Cl. 375/240.16; 375/E07.105

(57) ABSTRACT

A system and method for providing improved residual prediction for spatial scalability in video coding. In order to prevent visual artifacts in residual prediction in extended spatial scalability (ESS), each enhancement layer macroblock is checked to determine if the macroblock satisfies a number of conditions. If the conditions are met for an enhancement layer macroblock, then it is likely that visual artifacts will be introduced if applying residual prediction on the macroblock. Once such locations are identified, various mechanisms may be used to avoid or remove the visual artifacts.

### CROSS-REFERENCE TO RELATED APPLICATIONS

The present application claims priority to U.S. Provisional Patent Application No. 60/895,948, filed Mar. 20, 2007 and U.S. Provisional Patent Application No. 60/895,092, filed Mar. 15, 2007.

### FIELD OF THE INVENTION

The present invention relates generally to video coding. More particularly, the present invention relates to scalable video coding that supports extended spatial scalability (ESS).

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also know as ISO/IEC MPEG-4 AVC). In addition, there are currently efforts underway with regards to the development of new video coding standards. One such standard under development is the scalable video coding (SVC) standard, which will become the scalable extension to H.264/AVC. Another standard under development is the multivideo coding standard (MVC), which is also an extension of H.264/AVC. Yet another such effort involves the development of Chinese video coding standards.

The latest draft of the SVC is described in JVT-V201, “Joint Draft 9 of SVC Amendment,” 22nd JVT Meeting, Marrakech, Morocco, January 2007, available from http://ftp3.1tu.ch/av-arch/jvt-site/2007_{—}01_Marrakech/JVT-V201.zip, incorporated herein by reference in its entirety.

In scalable video coding (SVC), a video signal can be encoded into a base layer and one or more enhancement layers constructed in a layered fashion. An enhancement layer enhances the temporal resolution (i.e., the frame rate), the spatial resolution, or the quality of the video content represented by another layer or a portion of another layer. Each layer, together with its dependent layers, is one representation of the video signal at a certain spatial resolution, temporal resolution and quality level. A scalable layer together with its dependent layers are referred to as a “scalable layer representation.” The portion of a scalable bitstream corresponding to a scalable layer representation can be extracted and decoded to produce a representation of the original signal at certain fidelity.

Annex G of the H.264/Advanced Video Coding (AVC) standard relates to scalable video coding (SVC). In particular, Annex G includes a feature known as extended spatial scalability (ESS), which provides for the encoding and decoding of signals in situations where the edge alignment of a base layer macroblock (MB) and an enhancement layer macroblock is not maintained. When spatial scaling is performed with a ratio of 1 or 2 and a macroblock edge is aligned across different layers, it is considered to be a special case of spatial scalability.

For example, when utilizing dyadic resolution scaling (i.e., scaling resolution by a power of 2), the edge alignment of macroblocks can be maintained. This phenomenon is illustrated in FIG. 1, where a half-resolution frame on the left (the base layer frame 1000) is upsampled to give a full resolution version of the frame on the right (an enhancement layer frame 1100). Considering the macroblock MB₀ in the base layer frame 1000, the boundary of this macroblock after upsampling is shown as the outer boundary in the enhancement layer frame 1100. In this situation, it is noted that the upsampled macroblock encompasses exactly four full-resolution macroblocks—MB₁, MB₂, MB₃ and MB₄—at the enhancement layer. The edges of the four enhancement layer macroblocks MB₁, MB₂, MB₃ and MB₄ exactly correspond to the upsampled boundary of the macroblock MB₀. Importantly, the identified base layer macroblock is the only base layer macroblock covering each of the enhancement layer macroblocks MB₁, MB₂, MB₃ and MB₄. In other words, no other base layer macroblock is needed for a prediction for MB₁, MB₂, MB₃ and MB₄.

In the case of non-dyadic scalability, on the other hand, the situation is quite different. This is illustrated in FIG. 2 for a scaling factor of 1.5. In this case, the base layer macroblocks MB₁₀ and MB₂₀ in the base layer frame 1000 are upsampled from 16×16 to 24×24 in the higher resolution enhancement layer frame 1100. However, considering the enhancement layer macroblock MB₃₀, it is clearly observable that this macroblock is covered by two different up-sampled macroblocks-MB₁₀ and MB₂₀. Thus, two base-layer macroblocks, MB₁₀ and MB₂₀, are required in order to form a prediction for the enhancement layer macroblock MB₃₀. In fact, depending upon the scaling factor that is used, a single enhancement layer macroblock may be covered by up to four base layer macroblocks.

In the current draft of Annex G of the H.264/AVC standard, it is possible for an enhancement layer macroblock to be coded relative to an associated base layer frame, even though several base layer macroblocks may be needed to form the prediction.

According to the current draft of Annex G of H.264/AVC, a number of aspects of a current enhancement layer MB can be predicted from its corresponding base layer MB(s). For example, intra-coded macroblocks (also referred to as intra-MBs) from the base layer are fully decoded and reconstructed so that they may be upsampled and used to directly predict the luminance and chrominance pixel values at enhancement layer. Additionally, inter-coded macroblocks (also referred to as inter-MBs) from the base layer are not fully reconstructed. Instead, only prediction residual of each base layer inter-MB is decoded and may be used to predict enhancement layer prediction residuals, but no motion compensation is done on the base layer inter-MB. This is referred as “residual prediction.” In still another example, for inter-MBs, base layer motion vectors are also upsampled and used to predict enhancement layer motion vectors. Lastly, in Annex G of H.264/AVC, a flag named base_mode_flag is defined for enhancement layer MB. When this flag is equal to 1, the type, mode and motion vectors of the enhancement layer MB are to be fully-predicted (or inferred) from its base layer MB(s).

The distinction between conventional upsampling and residual prediction is illustrated in FIG. 3. As shown in FIG. 3, each enhancement layer MB (MB E, MB F, MB G, and MB H) has only one base layer MB (MB A, MB B, MB C, and MB D, respectively). Assuming that the base layer MB D is intra-coded, then the enhancement layer MB H can take the fully reconstructed and upsampled version of the MB D as a prediction, and it is coded as the residual between the original MB H, (noted as O(H)) and the prediction from the base layer MB D. Using “U” to indicate the upsampling function and “R” to indicate the decoding and reconstruction function, the residual can be represented by O(H)-U(R(D)). In contrast, if assuming MB C is inter-coded relative to a prediction from A (represented by P_{AC}) and MB G relative to a prediction from E (represented by P_{EG}) according to residual prediction, MB G is coded as O(G)-P_{EG}-U(O(C)-P_{AC}). In this instance, U(O(C)-P_{AC}) is simply the upsampled residual from the MB C that is decoded from the bit stream.

The above coding structure is complimentary to single-loop decoding, i.e., it is desirable to only perform complex motion compensation operations for one layer, regardless of which layer is to be decoded. In other words, to form an inter-layer prediction for an enhancement layer, there is no need to do motion compensation at the associated base layer. This implies that inter-coded MBs in the base layer are not fully reconstructed, and therefore fully reconstructed values are not available for inter-layer prediction. Referring again to FIG. 3, R(C) is not available when decoding G. Therefore, coding O(G)-U(R(C)) is not an option.

In practice, the residual prediction mentioned above can be performed in an adaptive manner. When a base layer residual does not help in coding a certain MB, prediction can be done in a traditional manner. Using MB G in FIG. 3 as an example, without using base layer residuals, the MB G can be coded as O(G)-P_{EG}. Theoretically, residual prediction helps when an enhancement layer pixel share the same or similar motion vectors as its corresponding pixel at the base layer. If this is the case for a majority of the pixels in an enhancement layer MB, then using residual prediction for the enhancement layer MB would improve coding performance.

As discussed above, for extended spatial scalability, a single enhancement layer MB may be covered by up to four base layer MBs. In the current draft of Annex G of the H.264/AVC video coding standard, when enhancement layer MBs are not edge-aligned with base layer MBs, for each enhancement layer MB, a virtual base layer MB is derived based on the base layer MBs that cover the enhancement layer MB. The type, the MB mode, the motion vectors and the prediction residuals of the virtual base layer MB are all determined based on the base layer MBs that cover the current enhancement layer MB. The virtual base layer macroblock is then considered as the only macroblock from base layer that exactly covers this enhancement layer macroblock. The prediction residual derived for the virtual base layer MB is used in residual prediction for the current enhancement layer MB.

More specifically, prediction residuals for the virtual base layer MB are derived from the prediction residuals in the corresponding base layer areas that actually cover the current enhancement layer MB after upsampling. In case of ESS, such residuals for the virtual base layer MB may come from multiple (up to four) base layer MBs. For illustration, the example shown in FIG. 2 is redrawn FIG. 4. In FIG. 4, the corresponding locations of enhancement layer MBs are also shown in the base layer with dashed-border rectangles. In macroblock MB3, for example, the prediction residuals in the shaded area in base layer are up-sampled and used as the prediction residuals of the virtual base layer MB for MB3. Similarly, for each 4×4 block in a virtual base layer MB, its prediction residual may also come from up to four different 4×4 blocks in base layer.

According to H.264/AVC, all of the pixels in a 4×4 block have to share the same motion vectors. This means that every pixel in an enhancement layer 4×4 block has the same motion vectors. However, for their corresponding base layer pixels, because they may come from different blocks, they do not necessarily share the same motion vectors. An example of this phenomenon is shown in FIG. 5. In FIG. 5, the solid-border rectangle represents a 4×4 block BLK0 at the enhancement layer, while the dashed-border rectangles represent upsampled base layer 4×4 blocks. It should be noted that although 4×4 blocks are used in the example to illustrate the problem, the same problem exists for other size blocks as well. In the example of FIG. 5, it is assumed that among the four base layer 4×4 blocks, only BLK2 has very different motion vectors than BLK0. In this case, residual prediction does not work for the shaded area in BLK0, but residual prediction may work well for the remaining area of BLK0. As a result, a large prediction error can be expected to be concentrated only in the shaded area with residual prediction. In addition, when the size of such a shaded area is relatively small, the prediction error in the shaded area is often poorly compensated with the transform coding system specified in H.264/AVC. As a consequence, noticeable visual artifacts are often observed in such area of reconstructed video.

More particularly, an issue arises due to a very unbalanced prediction quality within a block. When a portion of the block is very well predicted while the remaining area of the block is predicted poorly, the prediction error becomes highly concentrated in one section of the block. This is the primary reason for the introduction of visual artifacts. On the other hand, there is generally no problem when the prediction quality within a block is more balanced. For example, even if all pixels within a block are predicted poorly, visual artifacts are less likely to appear because, in this situation, the prediction error can be fairly compensated with the DCT coding system specified in H.264/AVC.

### SUMMARY OF THE INVENTION

Various embodiments of the invention provide a system and method for improving residual prediction for the case of ESS and avoiding the introduction of visual artifacts due to residual prediction. In various embodiments, in order to prevent such visual artifacts, each enhancement layer macroblock is checked to see if it satisfies the following condition. The first condition is whether the macroblock has at least one block that is covered by multiple base layer blocks. The second condition is whether the base layer blocks that cover the enhancement layer block do not share the same or similar motion vectors. If these two conditions are met for an enhancement layer macroblock, then it is likely that visual artifacts will be introduced if applying residual prediction on this macroblock. Once such locations are identified, various mechanisms may be used to avoid or remove the visual artifacts. As such, implementations of various embodiments of the present invention can be used to prevent the occurrence of visual artifacts due to residual prediction in ESS while preserving coding efficiency.

Various embodiments provide a method, computer program product and apparatus for encoding an enhancement layer representing at least a portion of a video frame within a scalable bitstream. According to these embodiments, a plurality of base layer blocks that cover an enhancement layer block after resampling are identified. Motion vector similarity is determined for the enhancement layer block based on whether the plurality of base layer blocks have motion vectors similar to a motion vector of the enhancement layer block. It is then determined whether a residual prediction from the plurality of base layer blocks is used in encoding the enhancement layer block based on the determined motion vector similarity.

Various embodiments also provide a method, computer program product and apparatus for encoding an enhancement layer representing at least a portion of a video frame within a scalable bitstream. According to these embodiments, a plurality of base layer blocks that cover an enhancement layer block after resampling are identified. Motion vector similarity is determined based on whether the plurality of base layer blocks have similar motion vectors. It is then determined whether a residual prediction from the plurality of base layer blocks is used in encoding the enhancement layer block based on the determined motion vector similarity.

Various embodiments also provide a method, computer program product and apparatus for decoding an enhancement layer representing at least a portion of a video frame within a scalable bitstream. According to these embodiments, a plurality of base layer blocks that cover an enhancement layer block after resampling are identified. Motion vector similarity is then determined for the enhancement layer block based on whether the plurality of base layer blocks have motion vectors similar to a motion vector of the enhancement layer block. It is then determined whether a residual prediction from the plurality of base layer blocks is used in encoding the enhancement layer block based on the determined motion vector similarity.

Various embodiments further provide a method, computer program product and apparatus for an enhancement layer representing at least a portion of a video frame within a scalable bitstream. According to these embodiments, a plurality of base layer blocks that cover an enhancement layer block after resampling are identified. Motion vector similarity is determined based on whether the plurality of base layer blocks have similar motion vectors. It is then determined whether a residual prediction from the plurality of base layer blocks is used in encoding the enhancement layer block based on the determined motion vector similarity.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 shows the positioning of macroblock boundaries in dyadic resolution scaling;

FIG. 2 shows the positioning of macroblock boundaries in non-dyadic resolution scaling;

FIG. 3 is a representation showing the distinction between conventional upsampling and residual prediction;

FIG. 4 shows a residual mapping process for non-dyadic resolution scaling;

FIG. 5 is a representation of an example enhancement layer 4×4 block covered by multiple 4×4 blocks from base layer;

FIG. 6 is a flow chart showing processes by which various embodiments of the present invention may be implemented;

FIG. 7 is a flow chart showing decoding processes by which various embodiments of the present invention may be implemented;

FIG. 8 is a flow chart showing both an encoding and a decoding process by which an embodiment of the present invention may be implemented;

FIG. 9 shows a generic multimedia communications system for use with the various embodiments of the present invention;

FIG. 10 is a perspective view of a communication device that can be used in the implementation of the present invention; and

FIG. 11 is a schematic representation of the telephone circuitry of the communication device of FIG. 10.

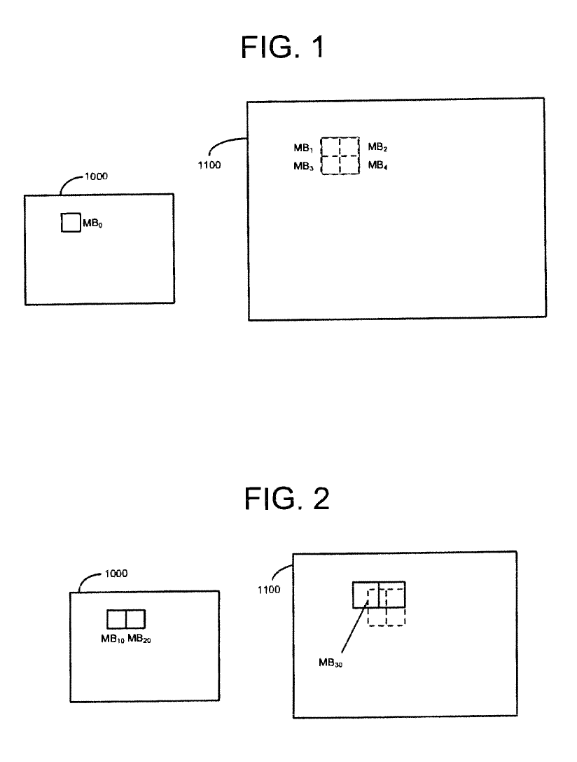

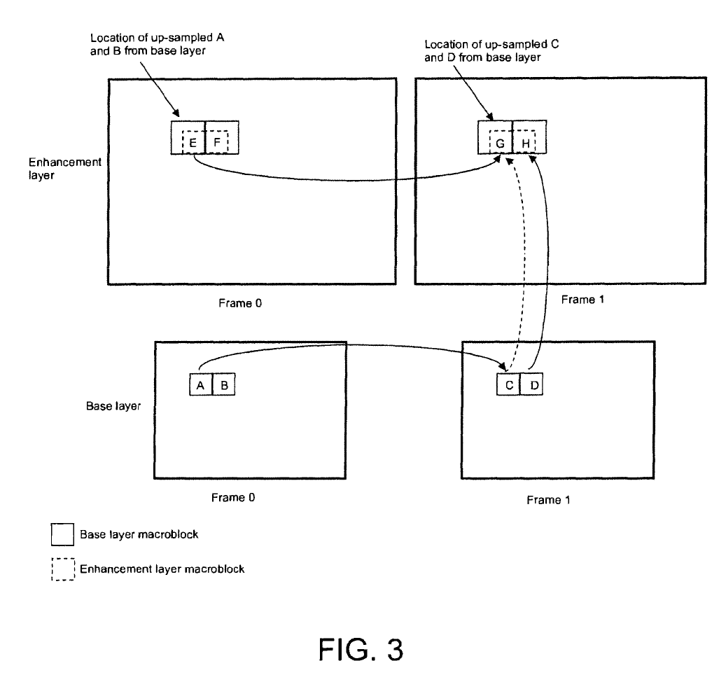

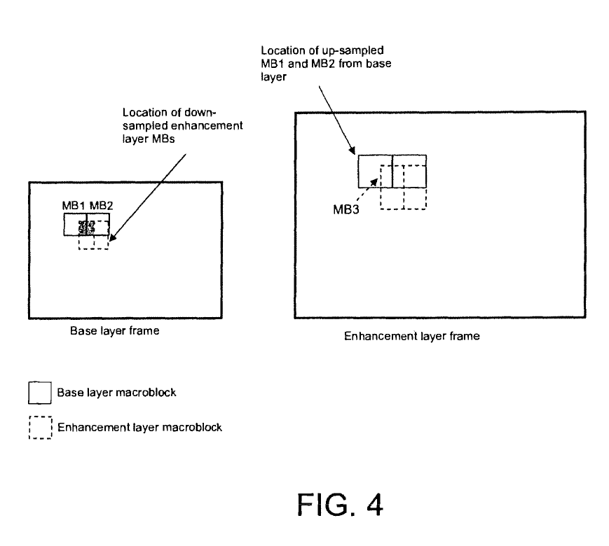

### DETAILED DESCRIPTION OF VARIOUS EMBODIMENTS

Various embodiments of the invention provide a system and method for improving residual prediction for the case of ESS and avoiding the introduction of visual artifacts due to residual prediction. In various embodiments, in order to prevent such visual artifacts, each enhancement layer macroblock is checked to see if it satisfies the following condition. The first condition is whether the macroblock has at least one block that is covered by multiple base layer blocks. The second condition is whether the base layer blocks that cover the enhancement layer block do not share the same or similar motion vectors.

In the above conditions, it is assumed that all pixels in a block share the same motion vectors. According to the conditions, if a block at enhancement layer is covered by multiple blocks from base layer and these base layer blocks do not share the same or similar motion vectors, it is certain that at least one of the base layer blocks has different motion vectors than the current block at enhancement layer. This is the situation in which visual artifacts are likely to appear.

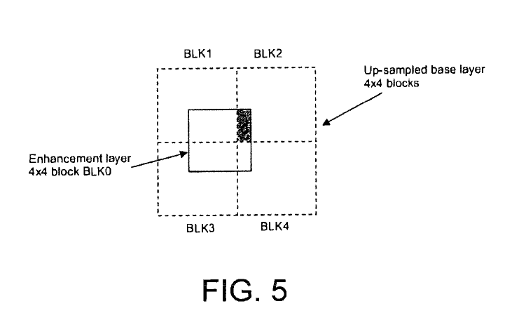

Revisiting FIG. 5, it is helpful to assume, that except for BLK2, the other three blocks—BLK1, BLK3 and BLK4—share the same or similar motion vectors. It is also assumed that at enhancement layer BLK0 has motion vectors that are the same or similar to BLK1, BLK3 and BLK4, which is very likely in practice. In this case, it is expected that the prediction error may be much larger for pixels in the shaded area than in the remaining area of the block when applying residual prediction. As discussed previously, visual artifacts are likely to appear in this situation due to the unbalanced prediction quality in BLK0. However, if BLK2 shares the same or similar motion vectors as the other three base layer blocks, no such issue arises.

The similarity of motion vectors can be measured through a predetermined threshold Tₘᵥ. Assuming two motion vectors are (Δx₁, Δy₁), (Δx₂, Δy₂), respectively, the difference between the two motion vectors can be expressed as: D((Δx₁, Δy₁), (Δx₂, Δy₂)). In this instance, D is a certain distortion measure. For example, the distortion measure can be defined as the sum of the squared differences between the two vectors. The distortion measure can also be defined as the sum of absolute differences between the two vectors. As long as D((Δx₁, Δy₁), (Δx₂, Δy₂)) is not larger than the threshold Tₘᵥ, the two motion vectors are considered to be similar. The threshold Tₘᵥ can be defined as a number, e.g. Tₘᵥ=0, 1 or 2, etc. Tₘᵥ can also be defined as a percentage number, such as within 1% of (Δx₁, Δy₁) or (Δx₂, Δy₂) etc. Some other forms of definition of Tₘᵥ are also allowed. When Tₘᵥ is equal to 0, it is required that (Δx₁, Δy₁) and (Δx₂, Δy₂) be exactly the same.

The two conditions used in determining whether it is likely for visual artifacts to be introduced are fairly easy to check in ESS, and the complexity overhead is marginal. Once locations for potential artifacts are identified, a number of mechanisms may be used to either avoid or remove the visual artifacts.

One method for avoiding or removing such visual effects involves selectively disabling residual prediction. In this embodiment, macroblocks are marked in the encoding process if it satisfies both the two conditions listed above. Then in the mode decision process (which is only performed at encoder end), residual prediction is excluded for these marked macroblocks. As a result, residual prediction is not applied to these macroblocks. One advantage to this method arises from the fact that the method is only performed at encoder end. As such, no changes are required to the decoding process. At the same time, because residual prediction is not applied to those macroblocks, visual artifacts due to residual prediction can be effectively avoided. Additionally, any penalty on coding efficiency that arises due to the switch-off of residual prediction on those macroblocks is quite small.

A second method for avoiding or removing such visual effects involves prediction residual filtering. In this method, for an enhancement layer MB, blocks that satisfy the two prerequisite conditions are marked. Then for all of the marked blocks, their base layer prediction residuals are filtered before being used for residual prediction. In a particular embodiment, the filters used for this purpose are low pass filters. Through this filtering operation, the base layer prediction residuals of the marked blocks become smoother. This effectively alleviates the issue of unbalanced prediction quality in the marked blocks and therefore prevents visual artifacts in residual prediction. At the same time, because this method does not forbid residual prediction in associated macroblocks, coding efficiency is well preserved. The same method applies to both the encoder and the decoder.

In this filtering process, it is possible to use different low pass filters. The low pass filtering operation is performed on those base layer prediction residual samples of the current block that are close to base layer block boundaries. For example, one or two residual samples on each side of the base layer block boundaries may be selected, and low pass filtering operation is performed at those sample locations. Alternatively, such filtering operations can also be performed on every base layer residual sample of the current block. It should be noted that two special filters are also covered in this particular embodiment. One such filter is a direct current filter that only keeps the DC component of a block and filters out all other frequency components. As a result, only the average value of prediction residuals are kept for a marked block. Another filter is a no-pass filter that blocks all frequency components of a block, i.e., setting all residual samples of a marked block to zero. In this case, residual prediction is selectively disabled on a block-by-block basis inside of a macroblock.

A third method for avoiding or removing such visual effects involves reconstructed sample filtering. Using this method, for an enhancement layer MB, blocks that satisfy the above two conditions are marked. In this method, no additional processing is needed on the base layer prediction residuals of those marked blocks. However, once an enhancement layer MB coded with residual prediction is fully reconstructed, a filtering process is applied to the reconstructed samples of the marked blocks in the MB to remove potential visual artifacts. The same method applies to both the encoder and the decoder. Therefore, instead of performing a filtering operation on residual samples, the filtering operation according to this method is performed on reconstructed samples.

As is the case for prediction residual filtering, different low pass filters may be used in the filtering process when reconstructed sample filtering is used. The low pass filtering operation is performed on those reconstructed samples of the current block that are close to base layer block boundaries. For example, one or two reconstructed samples on each side of base layer block boundaries may be selected, and low pass filtering operation is performed at those sample locations. Alternatively, such filtering operations can also be performed on every reconstructed sample of a marked block.

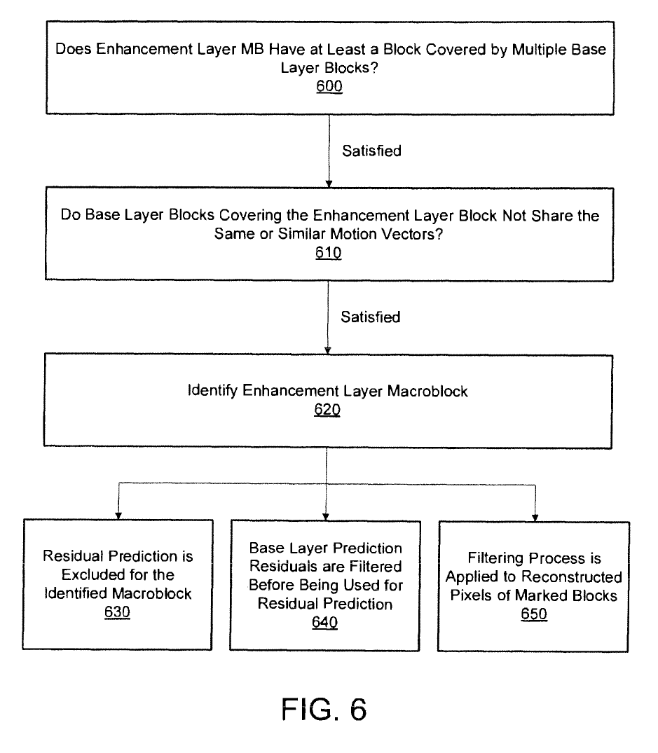

FIG. 6 is a flow chart showing processes by which various embodiments of the present invention may be implemented. At 600 in FIG. 6, an enhancement layer macroblock is checked to see if it has at least a block that is covered by multiple base layer blocks. At 610, if the condition at 600 is met, the same enhancement layer macroblock is checked to determine if the base layer blocks that cover the respective enhancement layer block do not share the same or similar motion vectors. If this condition is also met, then at 620 the enhancement layer macroblock is identified as being likely to result in visual artifacts if residual prediction is applied to it. At this point, and as discussed previously, a number of options are available to address the issue of visual artifacts. In one option and at 630, residual prediction is excluded for the identified/marked macroblock. In a second option and at 640, the base layer prediction residuals of marked blocks (i.e., blocks that satisfy the two conditions) are filtered before being used for residual prediction. In a third option and at 650, once the enhancement layer MB coded with residual prediction is fully reconstructed, a filtering process is applied to the reconstructed pixels of marked blocks (i.e., blocks that satisfy the two conditions) to remove potential visual artifacts.

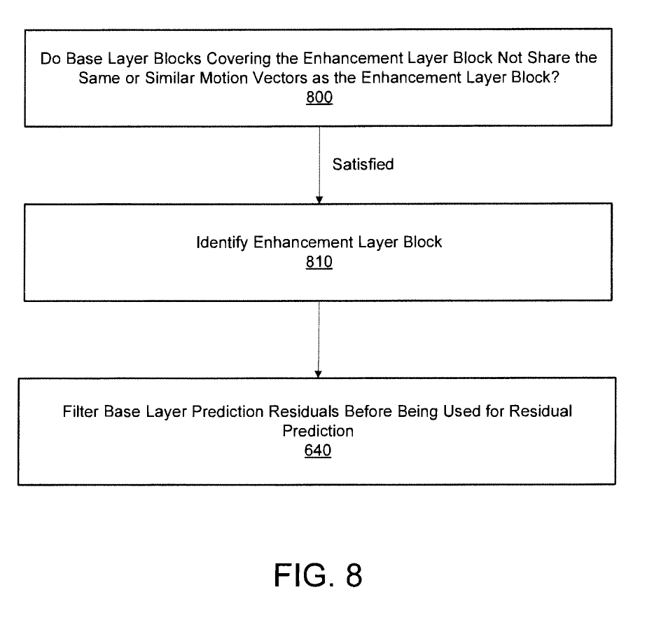

A fourth method for avoiding or removing such visual effect involves taking enhancement layer motion vectors into consideration. In this method, which is depicted in FIG. 8, it is determined whether an enhancement layer block does not share the same or similar motion vectors with its corresponding base layer blocks at 800. It should be noted that such a condition is more general than the two conditions discussed above because, as long as an enhancement layer block satisfies the two prerequisite conditions, it satisfies this particular condition. However, this condition covers other two scenarios as well. The first scenario is where an enhancement layer block is covered by only one base layer block, and where the enhancement layer block and its base layer block do not share the same or similar motion vectors. The second condition is where an enhancement layer block is covered by multiple base layer blocks, and these base layer blocks share the same or similar motion vectors between one another, but the enhancement layer block has different motion vectors from them. If the enhancement layer block does not share the same or similar motion vectors with its corresponding base layer blocks, then it is so marked at 810.

Under this method, for all of the marked blocks, their base layer prediction residuals are filtered at 820 before being used for residual prediction. It should be noted that all of the filtering arrangements mentioned in the second method of the present invention discussed above are applicable to this method as well. For example, this filter includes the no-pass filter that blocks all frequency component of a block, i.e., setting all residual samples of a marked block to zero. In this case, residual prediction is selectively disabled on a block-by-block basis inside of a macroblock under a residual prediction mode of an enhancement macroblock. This method applies to both the encoder and the decoder.

A fifth method for avoiding such visual effect is based on a similar idea to the fourth method discussed above, but this method is only performed at the encoder end. In this method, for residual prediction to work well, an enhancement layer block should share the same or similar motion vectors as its base layer blocks. Such a requirement can be taken into consideration during the motion search and macroblock mode decision process at the encoder end so that no additional processing is needed at decoder end. In order to achieve this, when checking the residual prediction mode during a mode decision process for an enhancement layer macroblock, the motion search for each block is to be confined in a certain search region that may be different from the general motion search region defined for other macroblock modes. For an enhancement layer block, the motion search region for residual prediction mode is determined based on the motion vectors of its base layer blocks.

To guarantee that an enhancement layer block shares the same or similar motion vectors as its base layer blocks, a motion search for the enhancement layer block is performed in a reference picture within a certain distance d from the location pointed by its base layer motion vectors. The value of distance d can be determined to be equal to or somehow related to the threshold Tₘᵥ, which is used in determining motion vector similarity.

If a current enhancement layer block has only one base layer block, then the motion search region is defined by base layer motion vectors and a distance d. If a current enhancement layer block is covered by multiple base layer blocks, then multiple regions are defined respectively by motion vectors of each of these base layer blocks and a distance d. The intersection area (i.e. overlapped area) of all of these regions is then used as the motion search region of the current enhancement layer block. In the event that there is no intersection area for all of these regions, the residual prediction mode is excluded from the current enhancement layer macroblock. Although the determination of the motion search region for each enhancement block requires some additional computation, a restriction on the search region size can significantly reduce the computation for a motion search. Overall, this method results in a reduction on encoder computation complexity. Meanwhile, this method requires no additional processing at the decoder.

A sixth method for avoiding such visual effect is based on a weighted distortion measure during the macroblock mode decision process at the encoder. Generally, in calculating distortion for a certain block, the distortion at each pixel location is considered on an equal basis. For example, the squared value or absolute value of the distortion at each pixel location is summed and the result is used as the distortion for the block. However in this method, the distortion at each pixel location is weighted in calculating the distortion for a block so that significantly larger distortion values are assigned to blocks where visual artifacts are likely to appear. As a result, when checking residual prediction mode during macroblock mode decision process, if visual artifacts are likely to appear, much larger distortion values will be calculated according to the weighted distortion measure. Larger distortion associated with a certain macroblock mode makes the mode less likely to be selected for the macroblock. If residual prediction is not selected due to the weighted distortion measure when visual artifacts are likely to appear, the issue can be avoided. This method only affects the encoder and does not require any additional processing at the decoder.

The weighting used in the sixth method described above can be based on a number of factors. For example, the weighting can be based on the relative distortion at each pixel location. If the distortion at a pixel location is much larger than the average distortion in the block, then the distortion at that pixel location is assigned a larger weighting factor in calculating the distortion for the block. The weighting can also be based on whether such relatively large distortion locations are aggregated, i.e., whether a number of pixels with relatively large distortions are located within close proximity of each other. For aggregated pixel locations with relatively large distortion, a much larger weighting factor can be assigned because such distortion may be more visually obvious. The weighting factors can be based on other factors as well, such as local variance of original pixel values, etc. Weighting may be applied to individual distortion values, or as a collective adjustment to the overall distortion of the block.

In addition to the above, many different criteria can be used for quantifying the terms in such a weighted distortion calculation. For example, what constitutes a “relatively large” distortion for a pixel can be based on a comparison to the average distortion in a block, or a comparison to the variance of distortions in a block, or on a comparison against a fixed threshold. As a further example, what constitutes an “aggregated” group of distortions can be based upon a fixed rectangular area of pixels, an area of pixels defined as being within some distance threshold of an identified “relatively large” distortion value, or an area of pixels identified based upon the location of block boundaries upsampled from a base layer. Other criteria based upon the statistical properties of the original pixel values, distortion values, or video frame or sequence as a whole are similarly possible. It is noted that these criteria may be combined into a joint measure as well. For example, the distortion values of a block may be filtered and a threshold applied so that the occurrence of a single value greater than the threshold indicates the presence of an aggregation of relatively large distortion values.

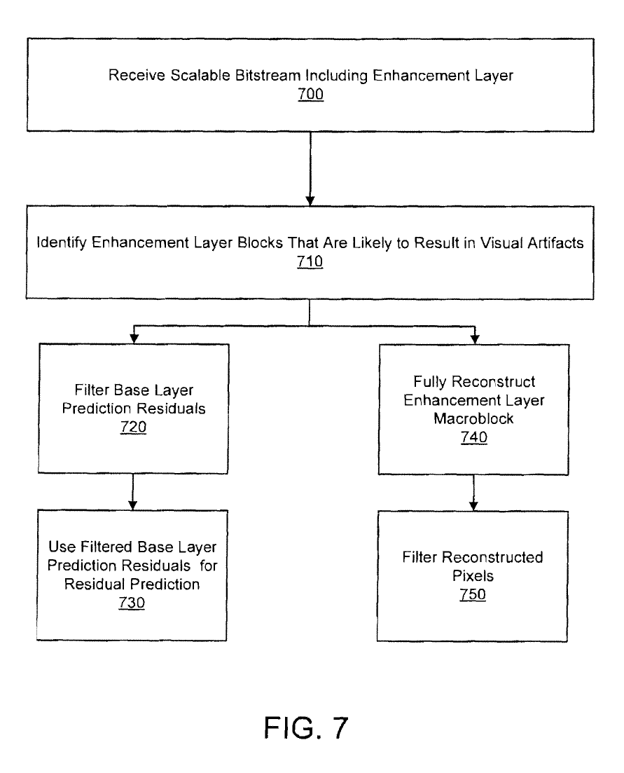

FIG. 7 is a flow chart showing decoding processes by which various embodiments of the present invention may be implemented. At 700 in FIG. 7, a scalable bitstream is received, with the scalable bitstream including an enhancement layer macroblock comprising a plurality of enhancement layer blocks. At 710, any enhancement layer blocks are identified that are likely to result in visual artifacts if residual prediction is applied thereto. In one embodiment, this is followed by filtering base layer prediction residuals for the identified enhancement layer blocks (at 720) and using the filtered base layer prediction residuals for residual prediction (at 730). In another embodiment, the process identified at 710 is followed by fully reconstructing the enhancement layer macroblock (at 740) and filtering reconstructed pixels of the identified enhancement layer blocks (at 750), thereby removing potential visual artifacts.

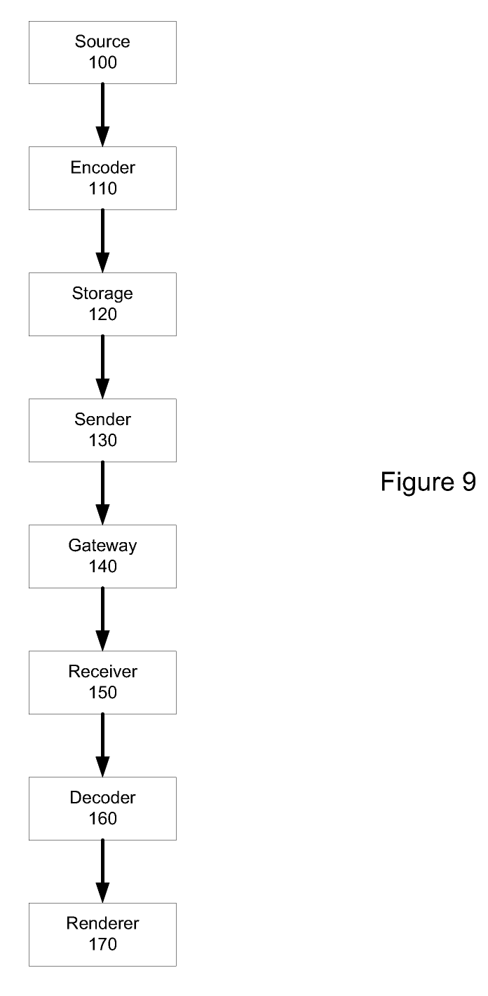

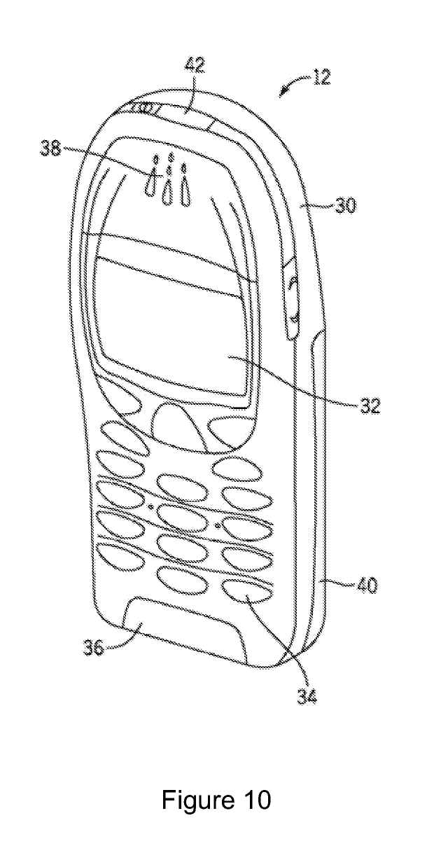

FIG. 9 shows a generic multimedia communications system for use with the present invention. As shown in FIG. 9, a data source 100 provides a source signal in an analog, uncompressed digital, or compressed digital format, or any combination of these formats. An encoder 110 encodes the source signal into a coded media bitstream. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the following only one encoder 110 is considered to simplify the description without a lack of generality.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. Some systems operate “live”, i.e. omit storage and transfer coded media bitstream from the encoder 110 directly to the sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the sender 130 may reside in the same physical device or they may be included in separate devices. The encoder 110 and sender 130 may operate with live real-time content, in which case the coded media bitstream is typically not stored permanently, but rather buffered for small periods of time in the content encoder 110 and/or in the sender 130 to smooth out variations in processing delay, transfer delay, and coded media bitrate.

The sender 130 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the sender 130 encapsulates the coded media bitstream into packets. For example, when RTP is used, the sender 130 encapsulates the coded media bitstream into RTP packets according to an RTP payload format. Typically, each media type has a dedicated RTP payload format. It should be again noted that a system may contain more than one sender 130, but for the sake of simplicity, the following description only considers one sender 130.

The sender 130 may or may not be connected to a gateway 140 through a communication network. The gateway 140 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 140 include multipoint conference control units (MCUs), gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 is called an RTP mixer and acts as an endpoint of an RTP connection.

The system includes one or more receivers 150, typically capable of receiving, de-modulating, and de-capsulating the transmitted signal into a coded media bitstream. The coded media bitstream is typically processed further by a decoder 160, whose output is one or more uncompressed media streams. It should be noted that the bitstream to be decoded can be received from a remote device located within virtually any type of network. Additionally, the bitstream can be received from local hardware or software. Finally, a renderer 170 may reproduce the uncompressed media streams with a loudspeaker or a display, for example. The receiver 150, decoder 160, and renderer 170 may reside in the same physical device or they may be included in separate devices.

It should be understood that, although text and examples contained herein may specifically describe an encoding process, one skilled in the art would understand that the same concepts and principles also apply to the corresponding decoding process and vice versa.

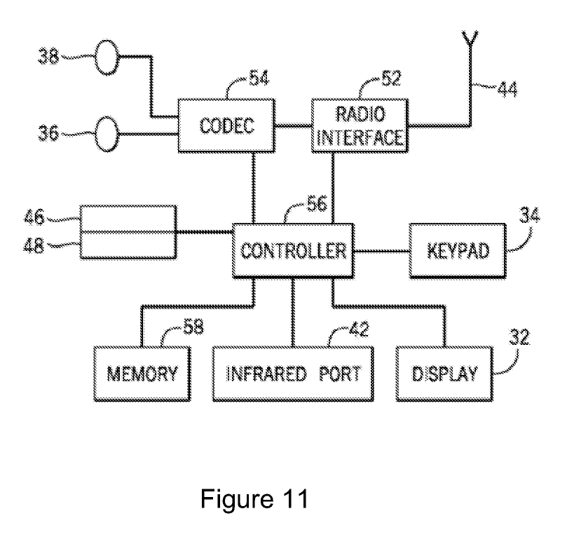

FIGS. 10 and 11 show one representative communication device 50 within which the present invention may be implemented. It should be understood, however, that the present invention is not intended to be limited to one particular type of communication device 50 or other electronic device. The communication device 50 of FIGS. 10 and 11 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56, a memory 58 and a battery 80. Individual circuits and elements are all of a type well known in the art, for example in the Nokia range of mobile telephones.

Communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

Various embodiments of present invention described herein are described in the general context of method steps, which may be implemented in one embodiment by a program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. Various embodiments of the present invention can be implemented directly in software using any common programming language, e.g. C/C++ or assembly language.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should also be noted that the words “component” and “module,” as used herein and in the claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method for encoding an enhancement layer representing at least a portion of a video frame within a scalable bitstream, comprising:
identifying a plurality of base layer blocks that cover an enhancement layer block after resampling;
determining motion vector similarity for the enhancement layer block based on whether the plurality of base layer blocks have motion vectors similar to a motion vector of the enhancement layer block; and
determining whether a residual prediction from the plurality of base layer blocks is used in encoding the enhancement layer block based on the determined motion vector similarity.

2. The method of claim 1, wherein the enhancement layer block is encoded using residual prediction from the plurality of base layer blocks only when the plurality of base layer blocks have similar motion vectors to the enhancement layer block.

3. The method of claim 1, further comprising, when a block of the plurality of the base layer blocks has a motion vector not similar to the motion vector of the enhancement layer block, applying a filtering operation to a base layer prediction residual corresponding to the enhancement layer block,
wherein the enhancement layer block is encoded using filtered residual prediction values from the base layer corresponding to the enhancement layer block.

4. The method of claim 1, further comprising, when a first block of the plurality of the base layer blocks has a motion vector not similar to the motion vector of the enhancement layer block:
reconstructing the enhancement layer block after residual prediction from the plurality of base layer blocks; and
applying a filtering operation to the reconstructed enhancement layer block around an area covered by the first block as resampled.

5. The method of claim 1, wherein motion vectors are considered to be similar if a distortion measure based on a difference between the motion vectors does not exceed a threshold value.

6. The method of claim 1, further comprising limiting a motion search area for the enhancement layer block such that the motion vector of the enhancement layer block is similar to the plurality of base layer blocks.

7. The method of claim 1, further comprising applying a weighted distortion measure for the enhancement layer block, wherein a distortion at each pixel location is weighted based on whether or not the pixel location is covered by a base layer block having a similar motion vector to the enhancement layer block.

8. A computer program product, embodied in a computer-readable storage medium, for encoding an enhancement layer representing at least a portion of a video frame within a scalable bitstream, comprising:
computer code configured to identify a plurality of base layer blocks that cover an enhancement layer block after resampling;
computer code configured to determine motion vector similarity for the enhancement layer block based on whether the plurality of base layer blocks have motion vectors similar to a motion vector of the enhancement layer block; and
computer code configured to determine whether a residual prediction from the plurality of base layer blocks is used in encoding the enhancement layer block based on the determined motion vector similarity.

9. The computer program product of claim 8, wherein the enhancement layer block is encoded using residual prediction from the plurality of base layer blocks only when the plurality of base layer blocks have similar motion vectors to the enhancement layer block.

10. The computer program product of claim 8, wherein motion vectors are considered to be similar if a distortion measure based on a difference between the motion vectors does not exceed a threshold value.

11. The computer program product of claim 8, further comprising computer code configured to apply a weighted distortion measure for the enhancement layer block, wherein a distortion at each pixel location is weighted based on whether or not the pixel location is covered by a base layer block having a similar motion vector to the enhancement layer block.

12. An apparatus for encoding an enhancement layer representing at least a portion of a video frame within a scalable bitstream, comprising:
a processor; and
a memory unit communicatively connected to the processor and including:
computer code configured to identify a plurality of base layer blocks that cover an enhancement layer block after resampling;
computer code configured to determine motion vector similarity for the enhancement layer block based on whether the plurality of base layer blocks have motion vectors similar to a motion vector of the enhancement layer block; and
computer code configured to determine whether a residual prediction from the plurality of base layer blocks is used in encoding the enhancement layer block based on the determined motion vector similarity.

13. The apparatus of claim 12, wherein the enhancement layer block is encoded using residual prediction from the plurality of base layer blocks only when the plurality of base layer blocks have similar motion vectors to the enhancement layer block.

14. The apparatus of claim 12, wherein motion vectors are considered to be similar if a distortion measure based on a difference between the motion vectors does not exceed a threshold value.

15. The apparatus of claim 12, wherein the memory unit further comprises computer code configured to apply a weighted distortion measure for the enhancement layer block, wherein a distortion at each pixel location is weighted based on whether or not the pixel location is covered by a base layer block having a similar motion vector to the enhancement layer block.

16. A method for encoding an enhancement layer representing at least a portion of a video frame within a scalable bitstream, comprising:
identifying a plurality of base layer blocks that cover an enhancement layer block after resampling;
determining motion vector similarity based on whether the plurality of base layer blocks have similar motion vectors; and
determining whether a residual prediction from the plurality of base layer blocks is used in encoding the enhancement layer block based on the determined motion vector similarity.

17. The method of claim 16, further comprising, when the plurality of the base layer blocks do not have similar motion vectors, applying a filtering operation to a base layer prediction residual corresponding to the enhancement layer block,
wherein the enhancement layer block is encoded using the filtered residual prediction values from the base layer corresponding to the enhancement layer block.

18. The method of claim 16, further comprising, when the plurality of the base layer blocks do not have similar motion vectors:
reconstructing the enhancement layer block after residual prediction from the plurality of base layer blocks; and
applying a filtering operation to the reconstructed enhancement layer block.

19. The method of claim 16, further comprising applying a weighted distortion measure for the enhancement layer block, wherein a distortion at each pixel location is weighted based on whether the plurality of base layer blocks share similar motion vectors.

20. The method of claim 16, wherein motion vectors are considered to be similar if a distortion measure based on a difference between the motion vectors does not exceed a threshold value.

21. A computer program product, embodied in a computer-readable storage medium, for decoding an enhancement layer representing at least a portion of a video frame within a scalable bitstream, comprising:
computer code configured to identify a plurality of base layer blocks that cover an enhancement layer block after resampling;
computer code configured to determine motion vector similarity based on whether the plurality of base layer blocks have similar motion vectors; and
computer code configured to determine whether a residual prediction from the plurality of base layer blocks is used in encoding the enhancement layer block based on the determined motion vector similarity.

22. The computer program product of claim 21, further comprising computer code configured to apply a weighted distortion measure for the enhancement layer block, wherein a distortion at each pixel location is weighted based on whether the plurality of base layer blocks share similar motion vectors.

23. The computer program product of claim 21, wherein motion vectors are considered to be similar if a distortion measure based on a difference between the motion vectors does not exceed a threshold value.

24. An apparatus for encoding an enhancement layer representing at least a portion of a video frame within a scalable bitstream, comprising:
a processor; and
a memory unit communicatively connected to the processor and including:
computer code configured to identify a plurality of base layer blocks that cover an enhancement layer block after resampling;
computer code configured to determine motion vector similarity based on whether the plurality of base layer blocks have similar motion vectors; and
computer code configured to determine whether a residual prediction from the plurality of base layer blocks is used in encoding the enhancement layer block based on the determined motion vector similarity.

25. The apparatus of claim 24, wherein the memory unit further comprising computer code configured to apply a weighted distortion measure for the enhancement layer block, wherein a distortion at each pixel location is weighted based on whether the plurality of base layer blocks share similar motion vectors.

26. The apparatus of claim 24, wherein motion vectors are considered to be similar if a distortion measure based on a difference between the motion vectors does not exceed a threshold value.

27. A method of decoding an enhancement layer representing at least a portion of a video frame within a scalable bitstream, comprising:
identifying a plurality of base layer blocks that cover an enhancement layer block after resampling;
determining motion vector similarity for the enhancement layer block based on whether the plurality of base layer blocks have motion vectors similar to a motion vector of the enhancement layer block; and
determining whether a residual prediction from the plurality of base layer blocks is used in encoding the enhancement layer block based on the determined motion vector similarity.

28. The method of claim 27, wherein the enhancement layer block is decoded using residual prediction from the plurality of base layer blocks only when the plurality of base layer blocks have similar motion vectors to the enhancement layer block.

29. The method of claim 27, further comprising, when a block of the plurality of the base layer blocks has a motion vector not similar to the motion vector of the enhancement layer block, applying a filtering operation to a base layer prediction residual corresponding to the enhancement layer block,
wherein the enhancement layer block is decoded using filtered residual prediction values from the base layer corresponding to the enhancement layer block.

30. The method of claim 27, further comprising, when a first block of the plurality of the base layer blocks has a motion vector not similar to the motion vector of the enhancement layer block:
reconstructing the enhancement layer block after residual prediction from the plurality of base layer blocks; and
applying a filtering operation to the reconstructed enhancement layer block around an area covered by the resampled first block.

31. The method of claim 27, wherein motion vectors are considered to be similar if a distortion measure based on a difference between the motion vectors does not exceed a threshold value.

32. A computer program product, embodied in a computer-readable medium, for decoding an enhancement layer representing at least a portion of a video frame within a scalable bitstream, comprising:
computer code configured to identify a plurality of base layer blocks that cover an enhancement layer block after resampling;
computer code configured to determine motion vector similarity for the enhancement layer block based on whether the plurality of base layer blocks have motion vectors similar to a motion vector of the enhancement layer block; and
computer code configured to determine whether a residual prediction from the plurality of base layer blocks is used in encoding the enhancement layer block based on the determined motion vector similarity.

33. The computer program product of claim 32, wherein the enhancement layer block is decoded using residual prediction from the plurality of base layer blocks only when the plurality of base layer blocks have similar motion vectors to the enhancement layer block.

34. The computer program product of claim 32, wherein motion vectors are considered to be similar if a distortion measure based on a difference between the motion vectors does not exceed a threshold value.

35. An apparatus for decoding an enhancement layer representing at least a portion of a video frame within a scalable bitstream, comprising:
a processor; and
a memory unit communicatively connected to the processor and including:
computer code configured to identify a plurality of base layer blocks that cover an enhancement layer block after resampling;
computer code configured to determine motion vector similarity for the enhancement layer block based on whether the plurality of base layer blocks have motion vectors similar to a motion vector of the enhancement layer block; and
computer code configured to determine whether a residual prediction from the plurality of base layer blocks is used in encoding the enhancement layer block based on the determined motion vector similarity.

36. The apparatus of claim 35, wherein the enhancement layer block is decoded using residual prediction from the plurality of base layer blocks only when the plurality of base layer blocks have similar motion vectors to the enhancement layer block.

37. The apparatus of claim 35, wherein motion vectors are considered to be similar if a distortion measure based on a difference between the motion vectors does not exceed a threshold value.

38. A method of decoding an enhancement layer representing at least a portion of a video frame within a scalable bitstream, comprising:
identifying a plurality of base layer blocks that cover an enhancement layer block after resampling;
determining motion vector similarity based on whether the plurality of base layer blocks have similar motion vectors; and
determining whether a residual prediction from the plurality of base layer blocks is used in encoding the enhancement layer block based on the determined motion vector similarity.

39. The method of claim 38, further comprising, when the plurality of base layer blocks do not have similar motion vectors, applying a filtering operation to a base layer prediction residual corresponding to the enhancement layer block,
wherein the enhancement layer block is decoded using filtered residual prediction values from the base layer corresponding to the enhancement layer block.

40. The method of claim 38, further comprising, when the plurality of base layer blocks do not have similar motion vectors:
applying a filtering operation to a base layer prediction residual corresponding to the enhancement layer block; and
decoding the enhancement layer block using filtered residual prediction values from the base layer corresponding to the enhancement layer block.

41. The method of claim 38, wherein motion vectors are considered to be similar if a distortion measure based on a difference between the motion vectors does not exceed a threshold value.

42. A computer program product, embodied in a computer-readable storage medium, for decoding an enhancement layer representing at least a portion of a video frame within a scalable bitstream, comprising:
computer code configured to identify a plurality of base layer blocks that cover an enhancement layer block after resampling;
computer code configured to determine motion vector similarity based on whether the plurality of base layer blocks have similar motion vectors; and
computer code configured to determine whether a residual prediction from the plurality of base layer blocks is used in encoding the enhancement layer block based on the determined motion vector similarity.

43. The computer program product of claim 42, wherein motion vectors are considered to be similar if a distortion measure based on a difference between the motion vectors does not exceed a threshold value.

44. An apparatus for decoding an enhancement layer representing at least a portion of a video frame within a scalable bitstream, comprising:
a processor; and
a memory unit communicatively connected to the processor and including:
computer code configured to identify a plurality of base layer blocks that cover an enhancement layer block after resampling;
computer code configured to determine motion vector similarity based on whether the plurality of base layer blocks have similar motion vectors; and
computer code configured to determine whether a residual prediction from the plurality of base layer blocks is used in encoding the enhancement layer block based on the determined motion vector similarity.

45. The apparatus of claim 44, wherein motion vectors are considered to be similar if a distortion measure based on a difference between the motion vectors does not exceed a threshold value.
